(19) United States
(12) Patent Application Publication
(10) Pub. No.: US 2010/0121680 A1
(43) Pub. Date: May 13, 2010

(54) METHOD AND SYSTEM FOR IDENTIFYING INSTALLATION SITES OF ALTERNATIVE FUEL STATIONS

(75) Inventors: Rob Elam, Seattle, WA (US); Michael Kudriavtseff, Seattle, WA (US); James Mark Austin, Seattle, WA (US)

Correspondence Address: PERKINS COIE LLP;PATENT-SEA, P.O. BOX 1247, SEATTLE, WA, 98111-1247, US

(73) Assignee: Propel Biofuels, Inc., Seattle, WA (US)

(21) Appl. No.: 12/556,529

(22) Filed: Sep. 9, 2009

Related U.S. Application Data
(60) Provisional application No. 61/095,551, filed on Sep. 9, 2008.

(51) Int. Cl. G06Q 10/00; G06Q 50/00

(52) U.S. Cl. 705/10; 705/348

(57) ABSTRACT

A method and system to identify suitable installation sites for alternative fuel stations. The system uses geocoded data sets and other data pertaining to a particular geographic market to generate three models: (1) the system generates a market capacity model that indicates the total number of stations that could be sustained by the present and/or projected consumer demand for alternative fuel within the market; (2) the system generates a hotspot model that indicates the geographic variation of estimated demand for alternative fuel within the market; and (3) the system generates a trade area model that indicates which locations within the market are quickly accessible by a sufficiently high number of alternative fuel consumers. When combined, these three models permit a user of the system to identify and analyze those locations within the market that are most suitable as alternative fuel station sites.

### CROSS REFERENCE TO RELATED APPLICATION

This application claims the benefit of U.S. Provisional Patent Application No. 61/095,551, entitled “METHOD AND SYSTEM FOR IDENTIFYING INSTALLATION SITES OF ALTERNATIVE FUEL STATIONS,” and filed on Sep. 9, 2008.

### BACKGROUND

In recent years, environmental issues have become an increasing concern both for government and for citizens. Some pollutants, such as sulfur dioxide, have been a concern for many years. More recently, pollutants that contribute to global warming, such as carbon dioxide, have grown in prominence as well. In particular, vehicles powered by gasoline or traditional diesel produce a significant portion of the carbon dioxide generated each year. There has been an increase in interest in using alternative fuels to reduce these emissions. Alternative fuels include biodiesel, which is produced from plant oils (most commonly soybean oil). They also include ethanol, which is generally produced from corn or sugar cane.

In order to make alternative fuels commercially viable, it is necessary to provide consumers with a fueling station infrastructure that distributes alternative fuels. The installation of this infrastructure, including the installation of pumps and tanks at alternative fuel stations, may require significant financial investments. If an alternative fuel station is sited at a location that is not near many consumers of alternative fuels, it may provide a lower return on investment or may fail. Inconveniently located alternative fuel stations may also discourage consumers from making a switch from gasoline to alternative fuels. Therefore, it would be useful to have a way to identify alternative fuel station sites that are readily accessible by consumers of alternative fuels.

### BRIEF DESCRIPTION OF THE DRAWINGS

FIG. 1 is a block diagram of an alternative fuel station siting system.

FIG. 2 is a flowchart of a process for siting alternative fuel stations that may be implemented by the alternative fuel station siting system of FIG. 1.

FIG. 3 is a flowchart of a process for developing a hotspot model for a market.

FIG. 4 illustrates a graphical display of a hotspot model generated by the system.

FIG. 5 is a flowchart of a process for developing a trade area model for a market.

FIG. 6 illustrates a graphical display of a trade area model generated by the system.

FIG. 7 is a flowchart of a process for analyzing hotspots located within trade areas.

FIG. 8 illustrates a graphical display of a hotspot model in conjunction with a trade area model.

FIG. 9 is a block diagram showing an example architecture of a computer.

### DETAILED DESCRIPTION

A method and system to identify suitable installation sites for alternative fuel stations (“stations”) is disclosed (hereinafter referred to as the “station siting system” or “system”). The system receives geocoded data sets and other data pertaining to a particular geographic market (the “market”). Using the received data, the system generates three models. First, the system generates a market capacity model that indicates the total number of stations that could be sustained by the present and/or projected consumer demand for alternative fuel within the market. Second, the system generates a hotspot model that indicates the geographic variation of estimated demand for alternative fuel within the market. The hotspot model allows a user of the system to quickly identify “hotspots,” that is, locations where demand may be particularly high. Third, using a drive-time analysis, the system generates a trade area model that indicates which locations within the market are quickly accessible by a sufficiently high number of alternative fuel consumers. When combined, these three models permit a user of the system to identify and analyze those locations within the market that are the most suitable for a station site.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

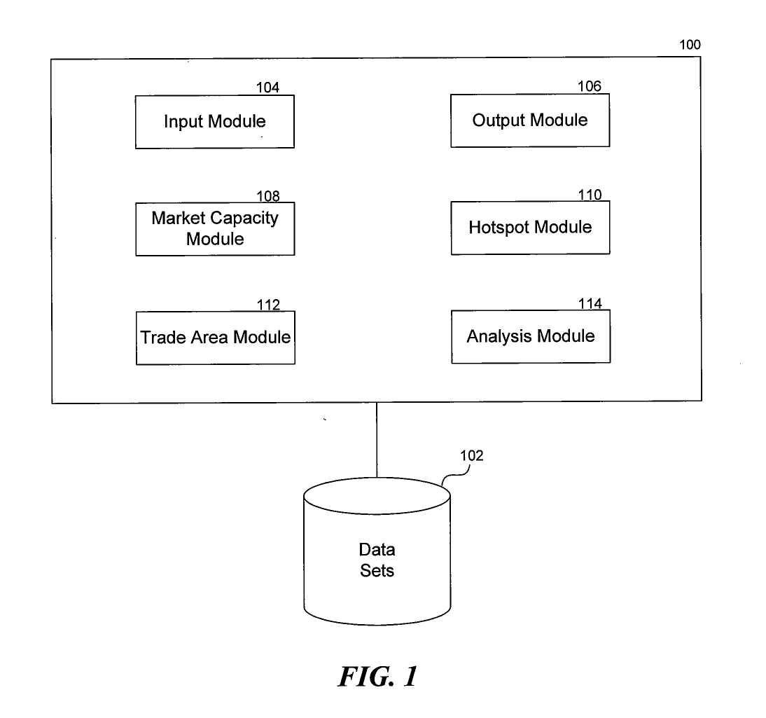

FIG. 1 is a block diagram of a station siting system 100 for identifying suitable installation sites for alternative fuel stations. The system 100 accesses one or more data sets 102. Using the data sets 102, the system 100 generates up to three models that permit a user to analyze whether various locations within a market are suitable for a station site.

As shown in FIG. 1, the system 100 has an input module 104, an output module 106, a market capacity module 108, a hotspot module 110, a trade area module 112, and an analysis module 114. The modules and their underlying code and/or data may be implemented in a single physical computing device or distributed over multiple physical computing devices, and the functionality may be implemented by calls to remote services. Similarly, the data sets shown could be in a single physical location, multiple physical locations, or could be on the same computing device as other modules in the system. Assuming a programmable implementation, the code to support the functionality of the system may be stored on a computer readable medium, such as an optical drive, flash memory, or a hard drive, and executed by one or more processors. One skilled in the art will appreciate that at least some of the individual modules may be implemented using application-specific integrated circuits (ASICs), programmable logic, or a general-purpose processor configured with software and/or firmware. Aspects of the system may also be implemented as special purpose hard-wired circuitry, programmable circuitry, or as a combination of these.

The input module 104 is configured to access data sets 102 that are linked to, referenced by, mapped to, associated with, or otherwise indexed by data indicative of geographical location. Such data sets 102 are hereinafter referred to as “geocoded data sets.” As a first example, a geocoded data set 102 might include consumer demographic information that is indexed by ZIP codes. As a second example, a geocoded data set 102 might include regional road network data that are associated with latitude and longitude data. These two examples are not intended to be exhaustive since innumerable other types of data may be geocoded, including but not limited to, census and tax records, vehicle registration records, traffic density and flow data, business names, landmarks, waterways and topological features, and consumer demographic information. Furthermore, geocoded data may be indexed by or associated with many different types of geographical identifiers or indexing data, including but not limited to, street addresses, ZIP codes, parcel lot numbers, and latitude and longitude. Furthermore, these geocoded data sets 102 may be obtained from commercial and/or non-commercial sources.

The output module 106 is configured to display, print or otherwise output geocoded data in a human-readable format. The displays or printouts produced by the output module 106 may be in the form of moving or still images, raster, vector or point features, text, sound or the like. The displays or other outputs produced by the output module 106 may also comprise a combination or composite of one or more of these forms. For example, the output module 106 may be configured to produce an image of a street map overlaid with aerial images and a color-coded raster layer indicative of a geocoded data set of numerical values.

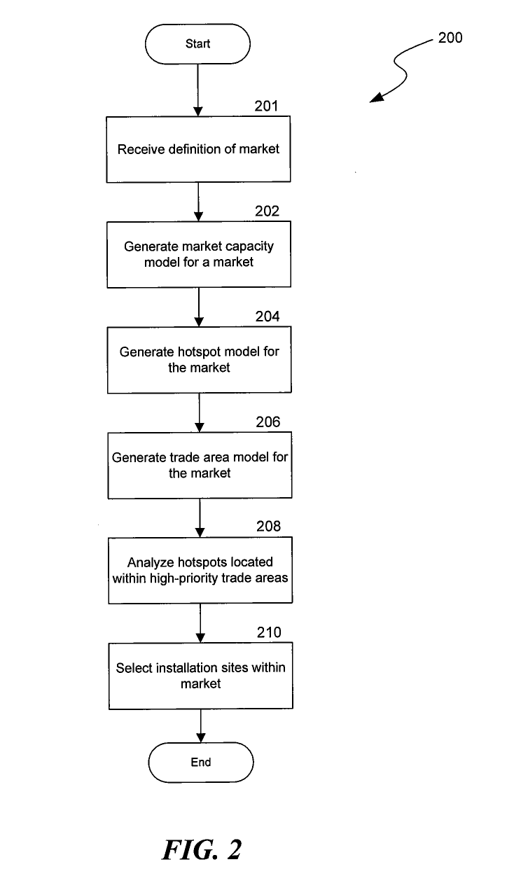

The system also has a market capacity module 108 for generating a market capacity model, a hotspot module 110 for generating a geocoded hotspot model, and a trade area module 112 for generating a geocoded trade area model. The three models and model-generating modules will be described in additional detail herein, in particular with respect to FIGS. 2 through 6.

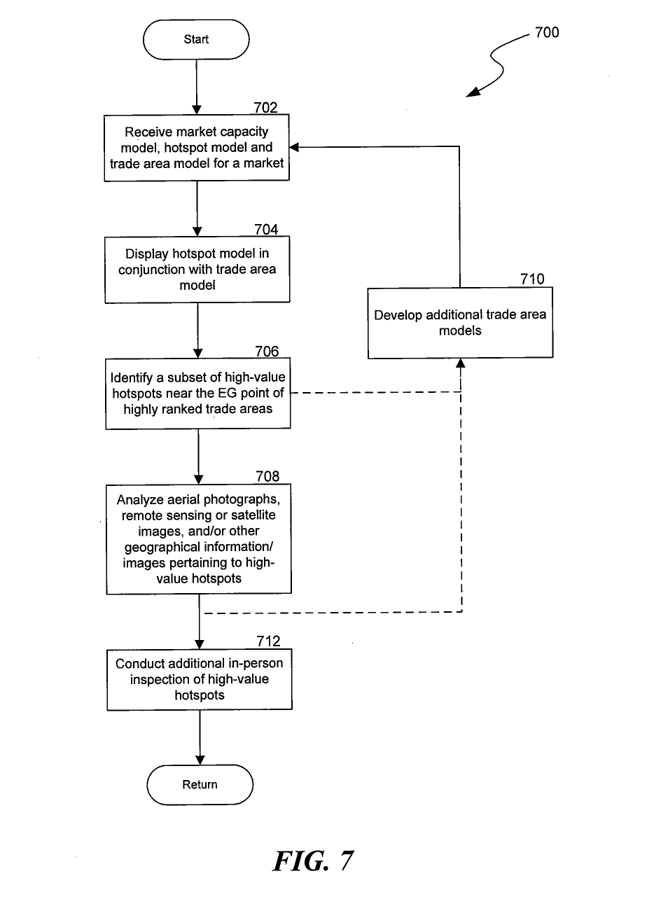

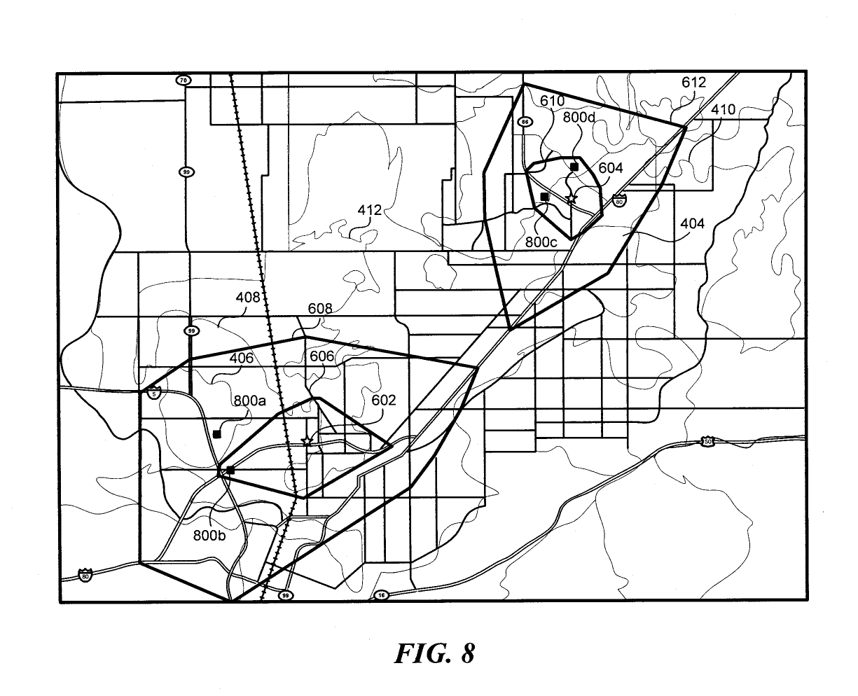

The system also has an analysis module 114 that permits a user of the system to analyze the generated models separately, in combination, and/or in conjunction with other geographical or geocoded data, information, images, or content. The functionality provided by the analysis module 114 will be discussed in greater detail herein with respect to FIGS. 7 and 8.

The various modules described, including the input module 104, output module 106, analysis module 114 and model-generation modules (market capacity module 108, hotspot module 110, and trade area module 112), may be partially or fully implemented using one or more of the geographical information systems (“GIS”) software programs known in the art, including, but not limited to, commercial products such as Google Earth, which is distributed by Google. Inc. of Mountain View, Calif., and ESRI ArcView, ArcGIS Spatial Analyst, ESRI ArcGIS Network Analyst, ESRI ArcView Network Analyst, and Arc2Earth, which are distributed by ESRI, Inc. of Redlands, Calif. The modules may also be implemented using non-commercial and/or open source products such as Geographic Resources Analysis Support System (GRASS), which is sponsored by the Open Source Geospatial Foundation. Some modules may also be implemented using other types of commercial or non-commercial software programs suitable for the manipulation and/or visualization of data, such as numerical analysis, or spreadsheet or database programs. For example, some modules may be implemented by Microsoft Excel, distributed by Microsoft Corp. of Redmond, Wash., Matlab, distributed by The MathWorks, Inc. of Natick, Mass., and/or the like. Alternatively, the various modules may be partially or fully implemented via customized computer software programs and/or hardware.

FIG. 2 is a flowchart of a process 200 for identifying suitable installation sites for stations that is implemented by the system. At a block 201, the system receives a market designated from a system user. A market may be a neighborhood, town, city, county, a Consolidated Base Statistical Area as defined by the U.S. Office of Management and Budget, or any bounded geographic area that is defined by the user. Once the market is defined, at a block 202 the market capacity module 108 generates a market capacity model that indicates the total number of stations that could be sustained by the present and/or projected consumer demand for alternative fuel within the market. Processing then proceeds to block 204, where the hotspot module 110 generates a hotspot model that indicates the geographic variation of estimated demand for alternative fuel within the market. The hotspot model allows a user of the system to quickly identify “hotspots,” that is, locations where demand may be particularly high. Processing then proceeds to block 206, wherein the system uses a drive-time analysis to generate a trade area model that indicates which locations within the market are quickly accessible by a sufficiently high number of alternative fuel consumers. In block 208, the system uses the analysis module 114 to enable the user to analyze hotspots located within high-priority trade areas. Processing then proceeds to block 210, where installation sites within the market are selected based on the results of the analysis. Each of these steps is described in further detail herein.

The market capacity model indicates the total number of stations that could be sustained by the present and/or projected consumer demand for alternative fuel within a market. To generate the market capacity model for a given market, the market capacity module 108 first receives or calculates the following actual, estimated, or projected information about the market:
the total number of alternative-fuel compatible vehicles (“compatible vehicles”) within the market (“N”) (compatible vehicles may include diesel fleet vehicles, diesel passenger cars and light-duty trucks, and/or flex-fuel compatible vehicles);
the percentage of market penetration among compatible vehicles (“P”);
the average volume of a fuel tank in an alternative-fuel compatible vehicle (“V”) (typically in gallons);
the average number of tank fillings made per compatible vehicle per year (“F”); and
the average volume of fuel that can be distributed annually by a single alternative fuel station (“S”) (typically in gallons).

One or more of these values may be received or calculated by the market capacity module 108 in the form of a numerical range. In one embodiment, the market capacity module 108 calculates a value or range of N by aggregating vehicle registration and/or fleet vehicle data indexed by ZIP code to the market level, where a market is defined as a Consolidated Base Statistical Area as defined by the U.S. Office of Management and Budget. Using these values, the market capacity module 108 determines the market's capacity for stations (“C”) by evaluating the following equation:

$$C = \frac{N * P * V * F}{S}$$

In some embodiments, the module may utilize a sensitivity analysis of this equation to provide an estimated range of capacities. In these embodiments, C may be expressed as a range. In some embodiments, the market capacity module 108 may simultaneously calculate C for multiple markets to provide a comparison of the capacity of various markets; in this manner, the system can permit a user to prioritize various markets.

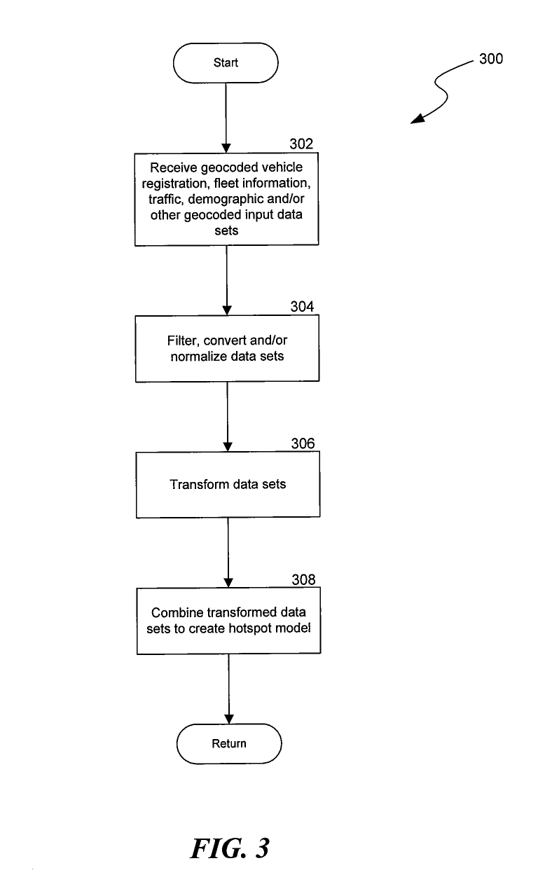

FIG. 3 is a flowchart of a process 300 for developing a hotspot model that is performed by the hotspot module 110. Processing begins in block 302, where the hotspot module 110 initially receives or accesses geocoded input data sets that may be indicative of consumer demand for alternative fuels and/or other predictors of commercial success. The following are non-exclusive examples of geocoded data sets that are received or accessed by the hotspot module 110 and which may be indicative of consumer demand and/or commercial success:
vehicle registration data (including make, model, and/or vehicle class) indexed by ZIP code or street address;
commercial fleet information indexed by ZIP code or street address;
traffic volume, flow, and/or density information indexed by street address or street intersection;
demographic or census information such as age, gender, marital status, annual income, and/or education level indexed by ZIP code or street address; and
other consumer information, such as average motor fuel expenditures and/or disposable income, indexed by ZIP code or street address.

After receiving the input data sets, processing proceeds to block 304, where the hotspot module 110 filters and/or converts some of the data sets into summary numerical data. For example, vehicle registration data indexed by ZIP code may be filtered to retain only those records corresponding to registered vehicles that are compatible with alternative fuel use. The filtered data may then be converted into a data set that numerically represents the density of compatible vehicles within each ZIP code or other geographic subdivision. Additionally, the hotspot module 110 may also normalize some of these data sets to unitless data before proceeding. Non-exclusive examples of appropriate normalizations include dividing each value in the data set by either (1) the mean of the data set, (2) the median of the data set, (3) the mean deviation of the data set, (4) a standard deviation of the data set, (5) an average absolute deviation, or (6) a value indicative of one or more moments of the data set.

As shown in FIG. 3, at block 306, each of the input data sets (and/or filtered/converted/normalized data sets) is mathematically transformed. The transformations may be linear (including an identity transformation) or non-linear. The transformations may also be invertible or non-invertible. Non-exhaustive examples of transformations to data sets include:
scaling the set (by a constant);
raising the set to a power;
taking a logarithm, derivative or integral of the set;
applying a ceiling or floor mapping to the set (i.e., quantization), and the like.
   The transformations applied to a data set may also merge a number of these simple exemplary transformations. For example, the hotspot module 110 may transform a data set by first applying a ceiling mapping, and then scaling the result. Also, a different transformation may be performed on each data set. For example, one data set may be scaled, while another data set may be quantized.

Processing then proceeds to block 308, where the various transformed data sets are mathematically combined to create the hotspot model. The combination may be linear or non-linear. Non-exclusive examples of combinations include any polynomial of the various transformed data sets, including a simple summation of the various transformed data sets. Although the various transformed data sets may be indexed by different types of geographical identifiers having different scales (e.g., one set may be indexed by ZIP codes, another by street address), GIS techniques and software tools are known in the art for readily effecting such a combination of disparate geocoded data, including ESRI ArcView and ESRI ArcGIS Spatial Analyst. Alternatively, the module may convert the geographical indexing of some data sets prior to the combination step to ensure that each data set is indexed by a common set of indexing data.

The hotspot module 110 generates the resultant hotspot model in any geocoded format that is readable by the analysis module 114 and the output module 106. For example, the hotspot model may be stored in KML form, point form, raster form, vector form, geodatabase form, or the like. Model generation may also be aided by additional GIS software tools that are configured to create readable geocoded file formats, such as Arc2Earth.

In one embodiment, the hotspot module 110 first normalizes each data set using the standard deviation of the data set (e.g., the standard deviation above and below the mean), and then scales each data set by a particular weighting constant, before finally summing the weighted data sets. Table 1 below summarizes the weighted linear combination that is utilized in one such embodiment.

TABLE 1
Weighted linear combination utilized by one embodiment of the
hotspot model generation process.

| Data Set | Weighting Constant |
|---|---|
| Per Capita Income | 5 |
| Average Fuel Purchases | 5 |
| Density of Traffic | 7 |
| Density of Diesel Vehicles: Passenger & Truck | 7 |
| Density of Diesel Vehicles: Fleets | 9 |
| Density of Flex Fuel Vehicles | 7 |

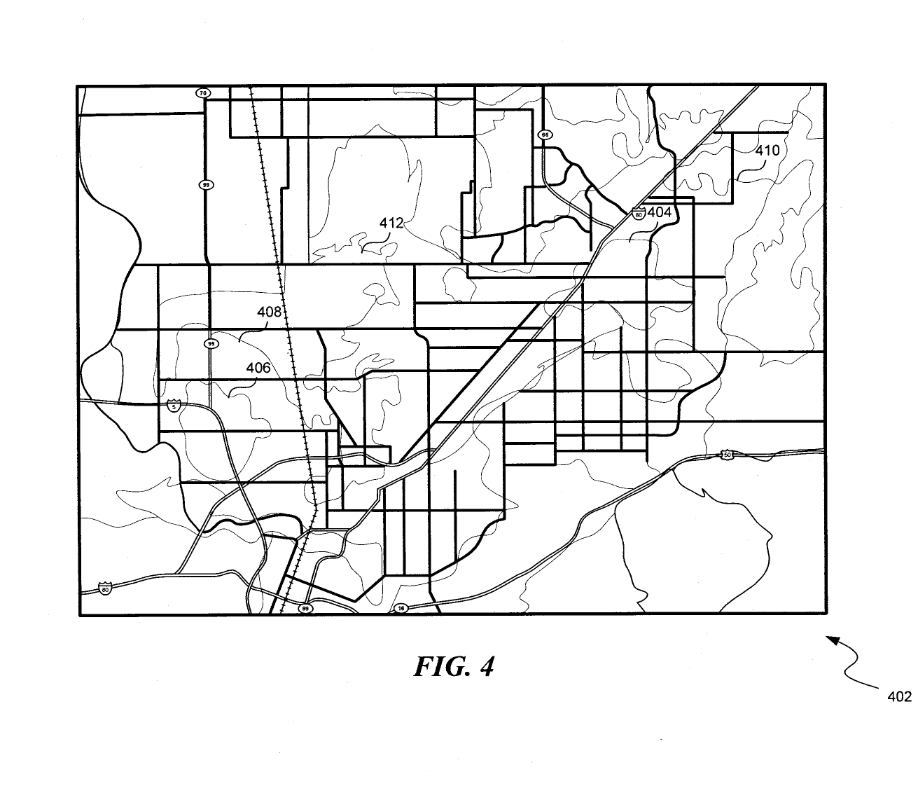

FIG. 4 illustrates a hotspot model generated by a weighted linear combination that is displayed in conjunction with a street map 402 using the output module 106 and the analysis module 114. “Hotspots” are regions that the hotspot model determines have a higher value relative to other areas in the market. In some embodiments, the geographic variation of the hotspot model is indicated graphically by a color gradient or grayscale gradient. For example, the map 402 in FIG. 4 uses a first grayscale level in areas 404 and 406 to indicate high relative value. Similarly, the second grayscale level in areas 408 and 410 indicates medium value. The third grayscale level in area 412 indicates a low relative value. As depicted in FIG. 4, when displayed graphically, the hotspot model readily conveys information regarding which areas within a market are likely to have greater consumer demand for alternative fuels. Other embodiments may utilize other types of graphical indicators besides color or grayscale gradients (e.g., highlighting, cross-hatching, etc.) to visually indicate the geographical variation of the hotspot model.

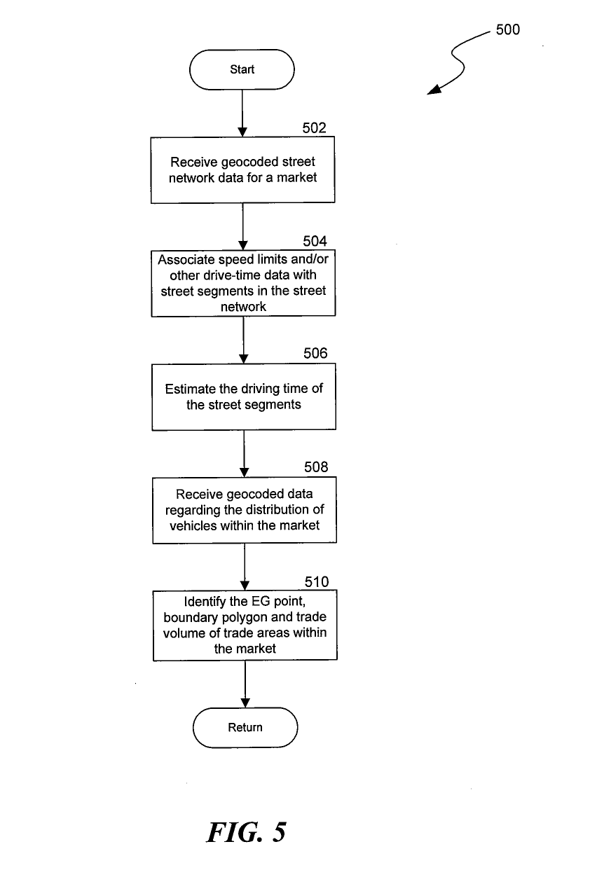

FIG. 5 is a flowchart of a process 500 for developing a trade area model for a market that is performed by the trade area module 112. Processing begins at block 502, where the module receives one or more geocoded data sets representing the street network of a market. The geocoded data sets may, for example, comprise data pertaining to street segments. Processing next proceeds to block 504, where the module associates the street network data with speed limits and/or other data that are indicative of the driving times of vehicles within the street network (e.g., typical observed traffic patterns). The module then proceeds to block 506, where it uses the received data to estimate the typical time needed to drive the length of each street segment within the street network. Drive-time analysis software programs and algorithms are known within the art that generate these estimates, including ESRI ArcGIS Network Analyst.

After estimating the drive time of street segments, processing proceeds to block 508, where the trade area module 112 receives geocoded data indicative of the distribution or density of compatible vehicles within the market. For example, the module may receive or access vehicle registration data (e.g., data pertaining to vehicle make, model, or class) that are indexed by street address or ZIP code and/or corporate diesel fleet data that are indexed by street address or ZIP code. Although not shown in FIG. 5, the module may filter and/or convert the received geocoded data into summary numerical data after the data has been received by the module. For example, vehicle registration and fleet data indexed by ZIP code may be filtered to retain only those records corresponding to compatible vehicles, and may then be converted into a data set that numerically represents the density of compatible vehicles within each ZIP code or other geographic subdivision.

Processing then proceeds to block 510, where the trade area module 112 uses the received geocoded data to identify trade areas that exist within a market. A trade area is a substantially polygon-shaped geographic area on a map of the market that satisfies two criteria. First, the polygon must have an equidistant geographical point (“EG point”) which may be reached from any point in the polygon within T minutes of estimated driving time, where T is a user-specified parameter (typically in minutes). Second, the polygon must circumscribe a geographic area having an estimated number of compatible vehicles of at least M, where M is a user-specified parameter. The estimated number of compatible vehicles circumscribed by a trade area polygon is hereinafter referred to as the “trade volume” of a trade area. While a polygon is used by the trade area module for computational purposes, it will be appreciated that other geometric shapes such as circles, ovals, rectangles, etc. may be used to identify trade areas.

In some embodiments, EG points may be limited to the center points (or centroid) of each ZIP code in the market and/or to certain other points or areas within the market. In some embodiments, trade area models may be developed for more than one value of T; for example, two models may be simultaneously developed, one for T=6 minutes and one for T=12 minutes. In some embodiments, trade areas may be chosen for M=0 or M=3000.

Commercial GIS tools may be utilized to identify trade areas automatically; non-exclusive examples include ESRI ArcGIS Network Analyst and ESRI ArcView Network Analyst. The set of all determined trade areas, including EG points, polygons, and trade volumes, is referred to as a “trade area model.” The trade area model may be generated in any geocoded format that is readable by the analysis module 114 and the output module 106. For example, the trade area model may be stored in KML form, point form, raster form, vector form, geodatabase form, or the like, or in a combination of these forms.

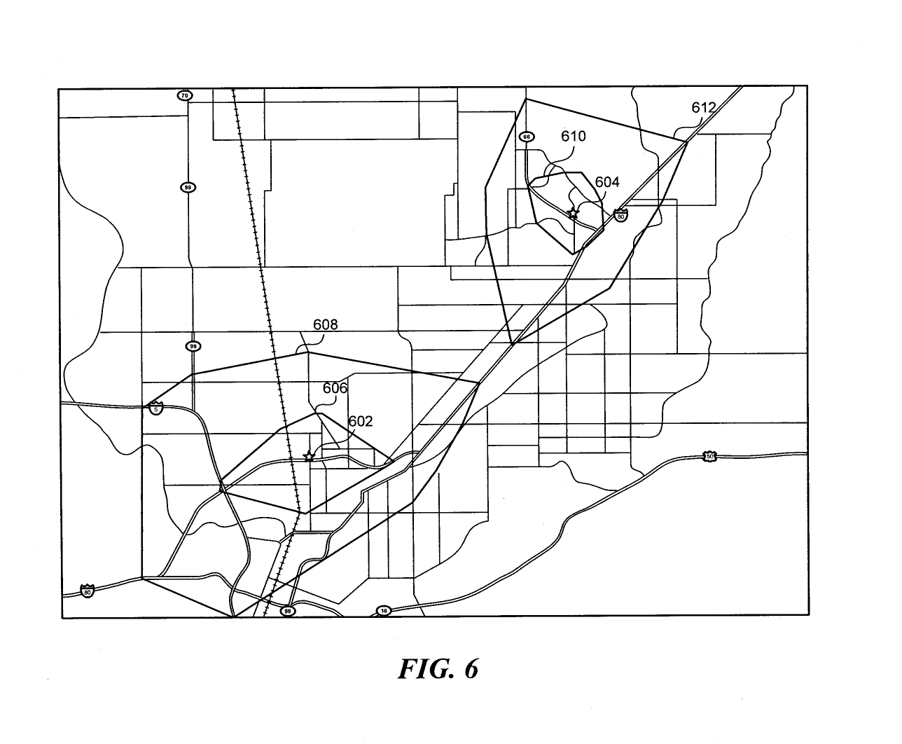

FIG. 6 illustrates two trade area models displayed by the system in conjunction with a street map. The stars 602 and 604 indicate EG points of various trade areas. The polygons 606, 608, 610, and 612 in the figure indicate the boundaries of the trade areas. The trade area model having smaller polygons 606 and 610 corresponds to T=6 minutes, the trade area model having bigger polygons 608 and 612 corresponds to T=12 minutes. As seen in FIG. 6, when displayed graphically, the trade area model readily conveys information regarding which locations within the market are quickly accessible for a large number of alternative fuel consumers.

FIG. 7 is a flowchart of a process 700 for analyzing hotspots located within trade areas. Some or all of the steps shown in FIG. 7 may be facilitated or implemented by the analysis module 114 and/or the output module 106. Processing begins in block 702, where the analysis module 114 receives a market capacity model, a hotspot model, and a trade area model. Although not shown in the figure, the analysis module 114 may also receive other geocoded data, models, and/or images pertaining to the market, including but not limited to street maps, aerial photographs, or satellite or remote sensing images.

After receiving all models and/or data, processing proceeds to block 704, where the system displays the hotspot model in conjunction with the trade area model in graphical form. Additionally, the system may display street maps, satellite photographs, aerial or remote sensing images and/or other types of geographical data or images in conjunction with these two models. FIG. 8 depicts the display of a hotspot model in conjunction with a trade area model, both overlaid on a street map. It will be appreciated that the display of FIG. 8 allows a user to quickly narrow down potential geographic locations for alternative fuel sites. The high relative value areas identified by the hotspot model (which are indicative of high consumer demand and/or other indicators of commercial success) may be quickly compared with the travel times generated by the trade area model (which are indicative of quick access to a large group of alternative fuel consumers). The overlap of the various regions generated by the hotspot model and trade area model provide a quick visualization tool that aids installation site selection.

Although not shown in FIG. 7, the analysis module 114 may also rank the various trade areas. To do so, the analysis module 114 may assign a higher-priority ranking to trade areas having a higher trade volume. The system may therefore also provide an indication of the relative rankings of the trade volumes. For example, the system may display a numerical rank next to each trade area.

After displaying the information, processing proceeds to block 706, where the analysis module 114 identifies those locations where a hotspot appears near an EG point of highly ranked trade areas. Hereinafter such locations will be referred to as “identified sites.” Such identified sites are likely to be highly suitable for a station site as they combine high consumer demand and/or other indicators of commercial success (as indicated by the relatively high value shown on the hotspot model) with quick access to a large group of alternative fuel consumers (as indicated by the trade area model). The analysis module 114 may present these identified sites to the user by adding additional graphical indicators to the display, such as an icon, graphic, arrow, or other identifier. In some embodiments, the analysis module 114 may first present a user with identified sites associated with higher-ranked trade areas before presenting identified sites in lower-ranked trade areas. In still other embodiments, the analysis module 114 may present the user with the identified sites associated with trade areas having the C highest trade volumes, where C is the market's capacity for stations, as determined by the market capacity model. For example, assuming the market in FIG. 8 has a predicted capacity of four fuel stations, the analysis module has identified four sites 800a-800d which are predicted as the best sites for the stations. Such sites are indicated with an icon, and combine, among other factors, proximity to EG points 602 and 604 and medium or high relative consumer demand as determined by the hotspot model.

Alternatively, in some embodiments, the analysis module 114 may permit a user to manually identify locations where the hotspot model has a particularly high value near a highly ranked EG point (also “identified sites”). For example, the analysis module 114 may permit a user to zoom in on a particular geographical location near a highly ranked EG point to inspect the values of the hotspot model near that geographical location. The analysis module 114 may also permit the user to add additional graphical indicators to the display at the location of the manually identified sites, to “bookmark” identified sites, and/or to rank identified sites.

As shown in FIG. 7 processing then proceeds to block 708, where the analysis module 114 permits a user to analyze aerial photographs and/or remote sensed or satellite images at or near identified sites to determine what physical features are present at the identified sites and/or locations near the identified sites. By allowing the user to analyze photographs or images, the user may determine whether each identified site has physical features suitable for an alternative fuel station. For example, by analyzing aerial photographs of identified sites, the user may determine whether there is an existing traditional gas station or sufficient undeveloped or underdeveloped space nearby that could make the installation of an alternative fuel station easier. Using this analysis, the user may develop a refined set of potential sites that have desirable physical characteristics, in addition to having a high hotspot model value and proximity to a highly ranked EG point. Such sites are referred to herein as “visually analyzed sites.” The analysis module 114 may also permit the user to add additional graphical indicators to the display at the location of the visually analyzed sites, to “bookmark” the location of these sites, and/or to rank or prioritize these visually analyzed sites. This portion of the analysis may be effectuated by GIS software such as Google Earth.

In some embodiments, the analysis module 114 or a user of the system may cause the trade area module 112 in block 710 to generate one or more additional trade area models based, on the results of previous steps in the analysis process. In some embodiments, at this step, the trade area module 112 may be limited to selecting EG points that are identified sites, visually analyzed sites and/or locations near these sites. In this way, the system permits the trade area model to be refined. In some embodiments, after new trade area models are generated, the steps of the analysis process shown in FIG. 7 are repeated using the newly-generated trade area models.

As shown, in FIG. 7, using the results provided by the analysis process, in block 712 an individual conducts an in-person inspection of potential sites. During an inspection, the individual may consider additional factors that would indicate commercial success. In particular, this inspection may evaluate the following characteristics of the site:
proximity to shopping centers, grocery stores, large retailers (“big box retailers”) and/or highway exits;
traffic access and density;
accessibility and visibility from the street;
attractiveness or appearance; or
amount of space available to accommodate alternative fuel tanks and/or pumps.

Weighing these factors along with the information provided by the analysis module 114, the system or user may select installation sites. In some embodiments, in order to select installation sites, the factors and analysis information may be entered into a Site Attribute Survey and graded on overall suitability for developing a station. In still other embodiments, to select installation sites, an economic model (e.g., pro forma) may be developed.

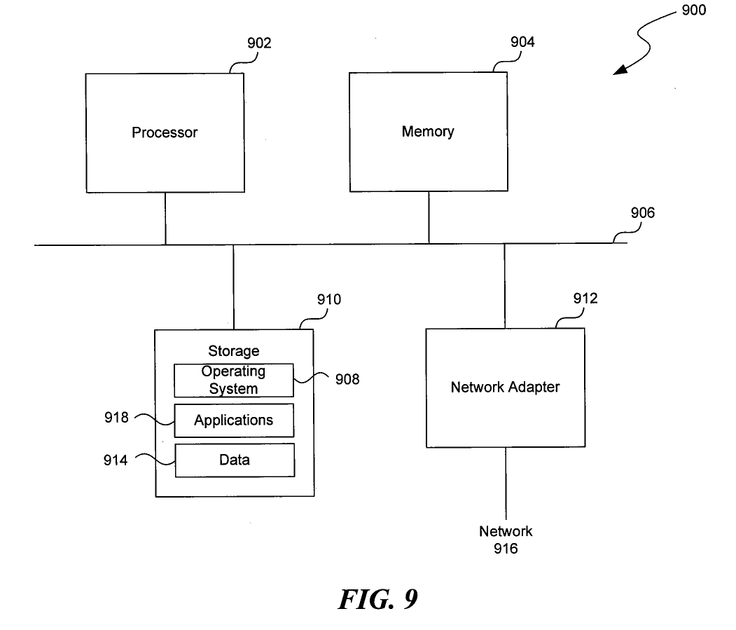

FIG. 9 is a high-level block diagram showing an example of the architecture of a computer 900. One or more computers 900 may be utilized by the system 100 to implement the station siting system described above. The computer 900 includes one or more processors 902 and memory 904 coupled to an interconnect 906. The interconnect 906 shown in FIG. 9 is an abstraction that represents any one or more separate physical buses, point-to-point connections, or both connected by appropriate bridges, adapters, or controllers. The interconnect 906, therefore, may include, for example, a system bus, a Peripheral Component Interconnect (PCI) family bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, sometimes referred to as “Firewire”.

The processor(s) 902 may include central processing units (CPUs) of the computer 900 and, thus, control the overall operation of the computer 900 by executing software or firmware. The processor(s) 902 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices. The memory 904 represents any form of random access memory (RAM), read-only memory (ROM), flash memory, or the like, or a combination of such devices.

The software or firmware executed by the processor(s) may be stored in a storage area 910 and/or in memory 904, and typically includes an operating system 908 as well as one or more applications 918. Data 914 utilized by the software or operating system is also stored in the storage area or memory. A network adapter 912 is connected to the processor(s) 902 through the interconnect 906. The network adapter 912 provides the computer 900 with the ability to communicate with remote devices over a network 916 and may be, for example, an Ethernet adapter.

Those skilled in the art will appreciate that the blocks shown in FIGS. 2, 3, 5 and 7 may be altered in a variety of ways. For example, the order of blocks may be rearranged, substeps may be performed in parallel, shown blocks may be omitted, other blocks may be included, or some blocks may be repeatedly or iteratively performed, etc.

For clarity, the processes shown in FIGS. 2, 3, 5 and 7 were described previously as being performed by particular modules or elements of the system of FIG. 1. However, these processes may also be performed by other modules or elements, or in other systems, or manually by a user, whether or not such elements or systems or manual steps are described herein.

From the foregoing, it will be appreciated that specific embodiments of the invention have been described herein for purposes of illustration, but that various modifications may be made without deviating from the spirit and scope of the invention.

I/we claim:

1. A computer-implemented method for identifying installation sites of alternative fuel stations, the method comprising:
generating a market capacity model, for a selected market, wherein the market capacity model indicates an estimated capacity for alternative fuel stations in the selected market;
generating a hotspot model indicating one or more hotspots within the selected market, wherein each hotspot is a geographical area within the selected market that is predicted to have high demand for alternative fuels and wherein the hotspot model is determined based on an actual or estimated number of vehicles in the selected market that are capable of using alternative fuels;
generating a trade area model indicating one or more trade areas, wherein each trade area is a geographical area within the selected market that is accessible within a threshold drive time by a minimum number of consumers of alternative fuels; and
generating a list of installation sites where alternative fuel stations should be sited based on the market capacity model, the hotspot model, and the trade area model.

2. The computer-implemented method of claim 1, wherein the market capacity model is generated based on at least one of: a total number of alternative fuel-compatible vehicles in the selected market, a market of alternative fuel-compatible vehicles in the selected market, an average volume of a fuel tank of an alternative fuel compatible vehicle, an average number of tank fillings made per compatible vehicle in a period of time, and an average volume of fuel that can be distributed by an alternative fuel station.

3. The computer-implemented method of claim 1, wherein the estimated capacity is a range determined using a sensitivity analysis.

4. The computer-implemented method of claim 1, wherein the hotspot model is generated based on at least one of: vehicle registration data indexed bygeographic location, commercial fleet information indexed by geographic location, traffic volume, flow, or density information indexed by geographic location, demographic information indexed by geographic location, and consumer income or expenditure information indexed by geographic location.

5. The computer-implemented method of claim 4, wherein the geographic location is a ZIP code or street address.

6. The computer-implemented method of claim 1, wherein generating the hotspot model includes performing a statistical transformation on a geocoded input data set, and wherein the statistical transformation is one of scaling the input data set, raising the input data set to a power, taking a logarithm of the input data set, taking a derivative of the input data set, taking an integral of the input data set, or quantizing the input data set.

7. The computer-implemented method of claim 1, further comprising ordering the list of installation sites based on an amount of trade volume in a corresponding trade area.

8. The computer-implemented method of claim 1, wherein the list of installation sites is generated based on geographical areas in which the one or more hotspots overlap with the one or more trade areas.

9. The computer-implemented method of claim 1, further comprising graphically displaying the list of installation sites on a map of the selected market.

10. A system for identifying installation sites of alternative fuel stations, the system comprising:
a processor;
a storage component coupled to the processor and containing instructions that, when executed by the processor, generate:
a market capacity model component configured to generate a market capacity model for a selected market, wherein the market capacity model indicates an estimated capacity for alternative fuel stations in the selected market;
a hotspot model component configured to generate a hotspot model indicating one or more hotspots within the selected market, wherein each hotspot is a geographical area within the selected market that is predicted to have high demand for alternative fuels and wherein the hotspot model is determined based on an actual or estimated number of vehicles in the selected market that are capable of using alternative fuels;
a trade area model component configured to generate a trade area model indicating one or more trade areas, wherein each trade area is a geographical area within the selected market that is accessible within a threshold drive time by a minimum number of consumers of alternative fuels; and
an analysis component configured to generate a list of installation sites where alternative fuel stations should be sited based on the market capacity model, the hotspot model, and the trade area model.

11. The system of claim 10, wherein the market capacity model component generates the market capacity model based on at least one of: a total number of alternative fuel-compatible vehicles in the selected market, a market of alternative fuel-compatible vehicles in the selected market, an average volume of a fuel tank of an alternative fuel compatible vehicle, an average number of tank fillings made per compatible vehicle in a period of time, and an average volume of fuel that can be distributed by an alternative fuel station.

12. The system of claim 10, wherein the hotspot model component generates the hotspot model based on at least one of: vehicle registration data indexed by geographic location, commercial fleet information indexed by geographic location, traffic volume, flow, or density information indexed by geographic location, demographic information indexed by geographic location, and consumer income or expenditure information indexed by geographic location.

13. The system of claim 12, wherein the geographic location is a ZIP code or street address.

14. The system of claim 10, wherein the hotspot model component generates the hotspot model based on geocoded input data sets indicative of consumer demand.

15. The system of claim 14, wherein the hotspot model component is further configured to normalize geocoded input data sets.

16. The system of claim 10, wherein the hotspot model component is configured to generate the hotspot model based on a weighted linear combination of multiple input data sets.

17. The system of claim 10, wherein the analysis component is further configured to order the list of installation sites based on an amount of trade volume in a corresponding trade area.

18. The system of claim 10, wherein the analysis component generates the list of installation sites based on geographical areas in which the one or more hotspots overlap with the one or more trade areas.

19. The system of claim 10, further comprising an output component configured to graphically display the list of installation sites on a map of the selected market.

20. A computer-readable medium containing instructions for identifying installation sites of alternative fuel stations, by a method comprising:
generating a market capacity model for a selected market, wherein the market capacity model indicates an estimated capacity for alternative fuel stations in the selected market;
generating a hotspot model indicating one or more hotspots within the selected market, wherein each hotspot is a geographical area within the selected market that is predicted to have high demand for alternative fuels and wherein the hotspot model is determined based on an actual or estimated number of vehicles in the selected market that are capable of using alternative fuels;
generating a trade area model indicating one or more trade areas, wherein each trade area is a geographical area within the selected market that is accessible within a threshold drive time by a minimum number of consumers of alternative fuels; and
generating a list of installation sites where alternative fuel stations should be sited based on the market capacity model, the hotspot model, and the trade area model.

21. The computer-readable medium of claim 20, wherein the market capacity model is generated based on at least one of: a total number of alternative fuel-compatible vehicles in the selected market, a market of alternative fuel-compatible vehicles in the selected market, an average volume of a fuel tank of an alternative fuel compatible vehicle, an average number of tank fillings made per compatible vehicle in a period of time, and an average volume of fuel that can be distributed by an alternative fuel station.

22. The computer-readable medium of claim 20, wherein the hotspot model is generated based on at least one of: vehicle registration data indexed by ZIP code or street address, commercial fleet information indexed by ZIP code or street address, traffic volume, flow, or density information indexed by ZIP code or street address, demographic information indexed by ZIP code or street address, and consumer income or expenditure information indexed by ZIP code or street address.

23. The computer-readable medium of claim 20, wherein the hotspot model is generated based on geocoded input data sets indicative of consumer demand.

24. The computer-readable medium of claim 23, wherein generating the hotspot model includes normalizing the geocoded input data sets.

25. The computer-readable medium of claim 20, wherein generating the hotspot model includes performing a statistical transformation on a geocoded input data set, wherein the statistical transformation is one of scaling the input data set, raising the input data set to a power, taking a logarithm of the input data set, taking a derivative of the input data set, taking an integral of the input data set, or quantizing the input data set.

26. The computer-readable medium of claim 20, wherein the list of installation sites is generated based on geographical areas in which the one or more hotspots overlap with the one or more trade areas.

27. The computer-readable medium of claim 20, further comprising graphically displaying the list of installation sites on a map of the selected market.

28. A computer-implemented method for identifying installation sites of alternative fuel stations, the method comprising:
receiving a definition of a selected market;
generating an estimated number of alternative fuel stations to serve consumer demand in the selected market;
identifying one or more geographical areas within the selected market that are predicted to have high demand for alternative fuels based on an actual or estimated number of vehicles in the selected market that are capable of using alternative fuels;
identifying one or more trade areas within the selected market, wherein each trade area is a geographical area within the selected market that is accessible within a threshold drive time by a minimum number of consumers of alternative fuels;
determining locations for each of the estimated number of alternative fuel stations based on the one or more identified geographical areas and the one or more trade areas; and
generating a graphical display of the selected market, the graphical display overlaying the identified one or more geographical areas and the identified one or more trade areas on a map of the selected market, the graphical display further displaying the determined locations for each of the alternative fuel stations.

29. The computer-implemented method of claim 28, wherein consumer demand is current demand or predicted demand.

30. The computer-implemented method of claim 28, wherein the estimated number of alternative fuel stations is generated based on at least one of: a total number of alternative fuel-compatible vehicles in the selected market, a market of alternative fuel-compatible vehicles in the selected market, an average volume of a fuel tank of an alternative fuel compatible vehicle, an average number of tank fillings made per compatible vehicle in a period of time, and an average volume of fuel that can be distributed by an alternative fuel station.

31. The computer-implemented method of claim 28, wherein the estimated number of alternative fuel stations is a range determined using a sensitivity analysis.

32. The computer-implemented method of claim 28, wherein the one or more geographical areas within the selected market that are predicted to have high demand for alternative fuels are identified based on at least one of: vehicle registration data indexed by geographic location, commercial fleet information indexed by geographic location, traffic volume, flow, or density information indexed by geographic location, demographic information indexed by geographic location, and consumer income or expenditure information indexed by geographic location.

33. The computer-implemented method of claim 32, wherein the geographic location is a ZIP code or street address.

34. The computer-implemented method of claim 28, wherein identifying one or more geographical areas includes performing a statistical transformation on a geocoded input data set, and wherein the statistical transformation is one of scaling the input data set, raising the input data set to a power, taking a logarithm of the input data set, taking a derivative of the input data set, taking an integral of the input data set, or quantizing the input data set.

35. The computer-implemented method of claim 28, further comprising ordering the locations for each of the estimated number of alternative fuel stations based on an amount of trade volume in a corresponding trade area.

36. The computer-implemented method of claim 28, wherein the locations for each of the estimated number of alternative fuel stations are determined based on areas of overlap between the one or more geographical areas and the one or more trade areas.
